(19) United States
(12) Patent Application Publication
(10) Pub. No.: US 2009/0282198 A1
(43) Pub. Date: Nov. 12, 2009

(54) SYSTEMS AND METHODS FOR OPTIMIZING BUFFER SHARING BETWEEN CACHE-INCOHERENT CORES

(75) Inventors: Nourredine HAMOUDI, Golfe-Juan (FR); Sripal A. BAGADIA, Dallas, TX (US)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 12/164,563

(22) Filed: Jun. 30, 2008

(30) Foreign Application Priority Data
May 8, 2008 (EP) 08290438.4

(51) Int. Cl. G06F 12/10

(52) U.S. Cl. 711/147; 711/206; 711/E12.061; 711/E12.066

(57) ABSTRACT

According to at least some embodiments, systems and methods are provided for mapping, by a first processor, of a memory portion that is inaccessible to a second processor to at least a segment of a pre-reserved region of memory addresses used by the second processor to enable the second processor to access the contents of the memory portion. The mapped memory portion comprising two temporary pages and all pages of data in a buffer to be shared excepting a first block of data and a last block of data, and copying the contents of the first block of data and the last block of data into its respective temporary page, at least one of the first and last blocks of data are unaligned prior to being copied into its respective temporary page. In some embodiments, at least one of the first and last blocks of data, prior to being copied into its respective temporary page, comprises a portion of data to be shared on a same cache line as a portion of data not to be shared.

### BACKGROUND

Microprocessors generally include a variety of logic circuits fabricated on a single semiconductor chip. Such logic circuits typically include a central processing unit (“CPU”) core, memory, and various other components. Some microprocessors, such as processors used in wireless devices provided by Texas Instruments, include more than one CPU core on the same chip. For example, some processors used in cellular phones have two processing cores. By way of example, one processing core, called the main processor unit (MPU) may process signals from a user interface (e.g., keypad) or a network interface, and perform various controlling functions, while another core, may function as a digital signal processor (DSP) and, as such, may perform multimedia processing.

In some multi-core devices, each CPU core connects to its own dedicated external memory. In other configurations both cores share a common memory. In performing a function that requires both processing cores to access the same data, the data from one core may be copied to shared memory from which the other core may access the data. This memory management scheme generally requires the system to statically reserve a region of shared memory in anticipation of future need.

In a high level operating system (HLOS), a user memory allocation application programming interface (API) enables the system to allocate buffers which are not necessarily page-aligned or cache-line-aligned. Mapping such unaligned buffers frequently is problematic for at least two reasons. First, data corruption occurs when a buffer is not cache-line-aligned, if the processors have data caches. Although each processor normally employs at least one scheme to avoid concurrent accesses to these shared buffers, if the shared buffers are not aligned on the cache line boundary, memory coherency issues occur when write-back or write-behind cache features are employed on unaligned buffers. Second, mapping unaligned buffers enables each processor to accidentally access another processor's private data which is contained in the shared, non-aligned buffer.

Reserving memory, overcoming addressable memory limitation, and copying data to shared memory for use by a core are among the many time-consuming and resource-intrusive tasks performed by electronic systems. Some systems, such as battery-operated cell phones, not only can have limited power, but also typically have limited space for memory. In such systems, it is generally desirable for microprocessors to require as little memory as possible and operate as fast as possible. Accordingly, any improvement in the memory usage of such processors that results in more efficient use of memory and achieves higher speed is highly desirable.

### BRIEF DESCRIPTION OF THE DRAWINGS

For a detailed description of exemplary embodiments, reference will be made to the accompanying drawings in which:

FIG. 1 illustrates a diagram of a system in accordance with embodiments;

FIG. 2 depicts a communication device (e.g., cellular telephone) in which embodiments may be used to advantage;

FIG. 3 illustrates a block diagram of an exemplary method of mapping memory between two different processing cores, according to embodiments;

FIG. 4 illustrates an exemplary page table, according to embodiments;

FIG. 5 illustrates a block diagram of an exemplary method of mapping, according to embodiments;

FIG. 6 illustrates a block diagram of an exemplary method of unmapping, according to embodiments;

FIG. 7 illustrates an example of memory blocks as mapping and unmapping occurs according to embodiments; and

FIG. 8 illustrates an exemplary general-purpose computer system suitable for implementing the several embodiments of the disclosure.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . . ” Also, the term “couple” or “couples” is intended to mean either an indirect or direct electrical connection. Thus, if a first device couples to a second device, that connection may be through a direct electrical connection, or through an indirect electrical connection via other devices and connections. The term “system” refers to a collection of two or more hardware and/or software components, and may be used to refer to an electronic device or devices or a sub-system thereof. Further, the term “software” includes any executable code capable of running on a processor, regardless of the media used to store the software. Thus, code stored in non-volatile memory, and sometimes referred to as “embedded firmware,” is included within the definition of software. Additionally, the term “processor” may be used synonymously with “processor core.”

### DETAILED DESCRIPTION

It should be understood at the outset that although exemplary implementations of embodiments of the disclosure are illustrated below, embodiments may be implemented using any number of techniques, whether currently known or in existence. This disclosure should in no way be limited to the exemplary implementations, drawings, and techniques illustrated below, including the exemplary design and implementation illustrated and described herein, but may be modified within the scope of the appended claims along with their full scope of equivalents.

One solution to the problems identified above is to copy the entire buffer to be shared into a temporary buffer which is page-aligned (4 KB aligned). This solves the page alignment as well as the cache-line alignment issues. However, this solution has significant processing overhead, as well as increased power and memory requirements for implementation. It should also be appreciated that memory protection may be somewhat enabled by painstaking appropriate setting of each core's MMU; however, to accurately perform such memory protection also relies on the shared buffer being aligned on a page boundary—which is not the case when, for example, default HLOS memory allocation methods are utilized.

In view of the above, embodiments provide optimized non-page-aligned buffer sharing between cache-incoherent cores. It should be appreciated that embodiments may be used with any multi-core architecture, and are particularly useful with those multi-core architectures lacking hardware cache coherency.

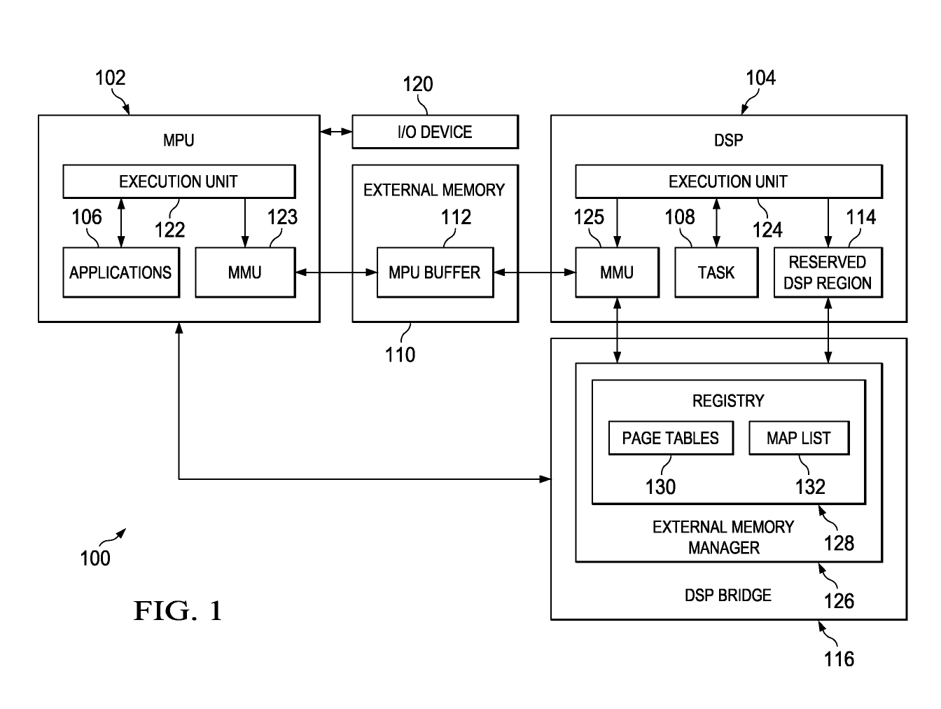

FIG. 1 illustrates a multi-core processing system in accordance with embodiments. It should be understood that, although system 100 is shown as comprising two processor cores 102 and 104, in some embodiments system 100 comprises additional processor cores. While processor 102 could be referred to as a source processor and processor 104 could be referred to as a destination processor for some of the functions described herein, and later switching designations (processor 102 as destination and processor 104 as source) for the remaining functions, for the sake of simplicity, ease of understanding and strictly for discussion purposes, processor 102 will be referred to as a main processor unit (“MPU”) and processor 104 preferably comprises a digital signal processor (“DSP”). Additionally, it is expressly understood that processor 104 could instead be the main processor unit, and processor 102 be a DSP or even other type of processor without deviating from the scope of the present teachings. It should be further understood that, in some embodiments, processors 102 and 104 processors may instead be peer processors, or even independent processors with the ability of at least one of them to access a share memory portion of the other processor.

MPU 102 of the embodiment of FIG. 1 is coupled to input/output (I/O) device 120, and manages the interaction between I/O device 120 and system 100. The I/O device 120 may comprise an input device (e.g., a mouse, a pointing device, a key pad, etc.) and/or an output device (e.g., a printer, a display, etc.). In some embodiments, MPU 102 further performs various other controlling functions for the system 100. DSP 104 preferably performs various multimedia processing functions such as video processing, encoding and/or decoding.

MPU 102 executes one or more applications 106; DSP 104 executes one or more task 108. Both the MPU 102 and the DSP 104 contain execution units 122 and 124, respectively, that comprise logic used to execute the applications 106 and task 108, respectively. Some embodiments of execution units 122 and 124 comprise processor core logic, e.g., fetch logic, decode logic, arithmetic logic, and the like. Both of the MPU and DSP also contain memory management units (MMU) 123 and 125, respectively. A DSP memory region 114 may be dynamically reserved at run-time and, as such, may not exist as part of system setup. The reserved DSP region 114 is a region of DSP addressable memory to which physical memory may be mapped; region 114 may also be considered working memory 114.

System 100 may also include external memory 110 coupled to both the MPU 102 and DSP 104 via memory management units (MMU) 123, 125 to thereby make at least a portion of memory 110 accessible to both processors. As a result, at least a portion of memory 110 may be shared by both processors, i.e., both processors are able to access the same shared memory locations. Further, a portion of memory 110 may be designated as private to one of the processors, e.g., private cache memory. Memory that is private to one processor is accessible by that processor only and may not be directly accessed by the other processor. It should be understood that external memory 110, in some embodiments, may instead be part of processor 102, but structured such that processor 104 can access at least some portion of external memory 110—or vice versa.

In the present discussion of FIG. 1, MMU 125 protects external memory 110 from illegal access and corruption of DSP task 108 by generally only enabling access to the region of memory 110 that has been mapped. A portion of memory 110 is implemented as buffer 112. The data buffer 112 is a portion of memory 110 that is private to MPU 102, and as such may be used exclusively for holding, for example, multimedia data.

System 100 further comprises bridge 116 which preferably implements an external memory manager 126. In some embodiments, bridge 116 may be implemented as a software program—comprised of instructions—that functions to bridge the two processing cores 102,104. In other embodiments, bridge 116 may instead be completely hardware, or a combination of software and hardware. At least a portion of bridge 116 may be executed by one or both processors 102, 104. In some embodiments, at least a portion of bridge 116 is executed in MPU 102, while other portions are executed in DSP 104. For example, in some embodiments, external memory manager 126 is preferably executed by MPU 102. External memory manager 126 is generally responsible for managing the use of memory on behalf of DSP 104. Accordingly, the external memory manager 126 may maintain a registry 128. The registry 128 preferably maintains a list of reserved DSP memory regions in page tables 130 and a list of mapped DSP memory regions in a map list 132.

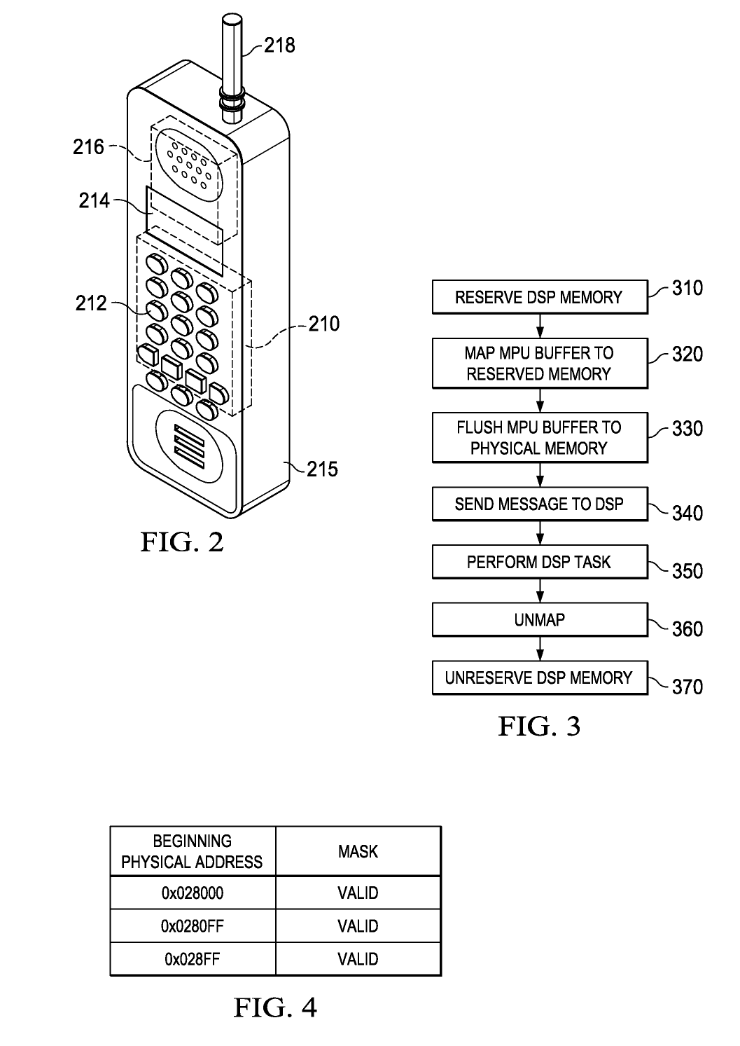

Embodiments of system 100 may also comprise other components such as a battery and an analog transceiver to permit wireless communications with other devices. As such, while system 100 may be representative of, or adapted to, a wide variety of electronic systems, FIG. 2 illustrates an exemplary system 100 in which embodiments may be used to advantage. As illustrated, system 100 comprises a mobile cell phone 215 with integrated keypad 212 and display 214, each of which is a separate embodiment of I/O device 120 of FIG. 1. MPU 102, DSP 104, and other components may be part of electronics package 210. Package 210 is coupled to keypad 212 and display 214. In some embodiments, electronics package 210 couples to a radio frequency (“RF”) circuit 216 in turn connected to an antenna 218.

FIG. 3 illustrates a flowchart for performing dynamic memory mapping between two different processing cores, such as for example, and not by way of limitation, in system 100. To better appreciate the present teachings, the overall process will be explained, followed by more details with respect to mapping and unmapping according to embodiments.

When MPU application 106 needs DSP 104 to perform a task 108 on data in memory buffer 112, the contents of memory buffer 112 is mapped to a specific region of memory private to DSP 104. Bridge 116 may, for example, inform task 108 of a request by MPU application 106 to process data in MPU buffer 112. As a result, task 108 may attempt to access MPU buffer 112 when an MPU application 106 has data that DSP 104 is to process.

In preparation for task 108's access of the data, at block 310, external memory manager 126 of bridge 116 preferably reserves a range of memory addresses of required size in the DSP addressable space, which will comprise reserved DSP region 114 or working memory 114. To accomplish this, in some embodiments, MPU application 106 determines the required size of DSP addressable space that is to be reserved based on the amount of data in MPU buffer 112 that DSP 104 is to process. MPU application 106 communicates the required size of DSP addressable space to external memory manager 126 which, in some embodiments, calls an application programming interface (API) function to perform the task of reserving region 114 memory addresses. The reserve memory API may be executed by MPU 102; it receives the requested size of memory to be reserved for use by DSP 104 and preferably causes the size to be an integer multiple of a predetermined page size. Thus, the reserve memory API may round-up the determined size to the next integer multiple of page size. In a preferred embodiment, the predetermined page size is equal to 4 KB, although it should be understood that embodiments are not necessarily so limited. For example, and without limitation, the predetermined page size may be 64 KB. As a result the predetermined page size may differ among embodiments, as other page sizes are possible. After determining the required size of memory, the reserve memory API locates an unused contiguous region of the appropriate size in private DSP memory region 114.

It should be understood that in some embodiments, although not separately shown for the particular embodiment of FIG. 1, MPU applications 106 may comprise a dynamic memory manager; while in other embodiments, a specific MPU application 106 may call a separate dynamic memory manager, etc. located in applications 106 or DSP bridge 116. In some embodiments, such a dynamic memory manager application coordinates the allocation of memory, and, in some embodiments calls the HLOS API. In at least some embodiments, the dynamic memory manager application may be implemented to work with MMU 123 to accomplish the discussed functions. Such dynamic memory manager may be implemented entirely in software, entirely in hardware, or in a combination of both.

After a suitable region has been found, in some embodiments, reserve memory API registers at least the beginning address of the region 114 in page table 130. The number of page table entries (PTEs) for page table 130 preferably is equal to the size of the reserved region 114 divided by the page size (e.g., 4 KB). Thus, in at least some embodiments, for each 4 KB section of the memory region, there is one PTE in the page table. An exemplary page table 130, illustrated in FIG. 4, which contains a list of the beginning physical addresses of each 4 KB section of the reserved DSP memory region. It should be understood that there could be more or less beginning physical addresses listed—again depending upon the amount of needed memory which has been reserved. Additionally, for each 4 KB section in table 130, there is a corresponding mask that is preferably set to VALID after the corresponding 4 KB section has been mapped. Setting the mask to VALID indicates that the corresponding 4 KB section has been mapped. Corresponding 4 KB sections that are not mapped are designated as INVALID. The index of the page table is preferably the offset of each 4 KB page from the beginning physical address of the reserved DSP region 114.

Returning to FIG. 3, after the required memory has been reserved, MPU buffer 112 is mapped to reserved memory region 114 (block 320). The procedure of mapping MPU buffer 112 to the reserved memory addresses may be performed, in some embodiments, by an API mapping function. The mapping API may be executed by MPU 102. The mapping API function adds the beginning address of the newly reserved region of memory to map list 132 (FIG. 1). Map list 132 preferably contains a list of beginning addresses and the particular size of each DSP memory address range which are being used for the mapping. The mapping API function preferably also adds an entry to list 132, once mapping is complete, to indicate that the particular region of memory is mapped and cannot presently be used/re-used.

After adding an entry to map list table 132, in some embodiments, the mapping API function confirms that the size of MPU buffer 112 is an integer multiple of 4 KB. If the MPU buffer is not an integer multiple of 4 KB, the mapping API calculates an additional amount of memory to map to accommodate for 4 KB mapping. The optimized mapping that occurs when the size of the MPU buffer extends beyond the last 4 KB page boundary and/or when the MPU buffer does not start at the beginning 4 KB page boundary but at some offset from the beginning 4 KB page boundary will be discussed in more detail below. However, generally only the offset start-address of MPU buffer 112 is returned to application 106, external memory manager 126, and/or task 108.

Beginning from the first 4 KB page of MPU buffer 112, the physical addresses of the entire page is mapped to corresponding DSP memory address spaces within reserved region 114. After the physical addresses of the first 4 KB page section of MPU buffer 112 have been mapped, the corresponding PTE in page tables 130 is set to VALID to signal that the page has been mapped. This process is repeated for the remaining portions of MPU buffer 112, preferably in sequential 4 KB page sections, until the entire buffer 112 is mapped to DSP region 114. Further details of example systems and methods for some embodiments of dynamic memory mapping may also be found in U.S. patent application Ser. No. 10/833,568, for “Dynamic Memory Mapping”, hereby incorporated by reference in its entirety herein.

After MPU buffer 112 is mapped to reserved region 114, the contents of buffer 112 are flushed to physical memory (block 330). Flushing buffer 112, in some embodiments, moves the contents of MPU buffer 112 from private cache memory into a shared memory region of external memory 110. The reason for flushing buffer 112 results from the fact that when data is stored in MPU buffer 112 some data may, at times, be cached and not be stored in the shared memory region of the external memory 110. Because the data that is cached is normally not accessible to DSP 104, task 108 may also not be able to access such cached data. Therefore, to ensure that such cached data is not lost and DSP 104 has access to the most recent data from MPU 102, MPU application 106 preferably calls an API to flush the memory. The flush memory API preferably flushes the contents of MPU buffer 112 into any shared memory region of external memory 110 to which DSP 104 has access. For purposes of the present discussion, the data contents flushed to the shared memory region of external memory 110 will continue to be referred to as MPU buffer 112. In alternative embodiments, the objectives of ensuring that cached data is not lost and the DSP 104 has access to the most recent data from the MPU 102 may instead be achieved by invalidating the cache. When the cache is invalidated, applications that are to access the cache instead read the data from the shared memory. The data is also written back to the shared memory instead of the cache, so long as the cache is invalidated. Although the foregoing describes different embodiments for flushing of the contents of MPU buffers, it is to be noted that similar flushing embodiments can also be performed on DSP buffers.

After MPU buffer 112 is successfully mapped to a pre-reserved region 114 of DSP 104, application 106 preferably communicates the starting address of DSP region 114 to task 108 to facilitate accessing MPU buffer 112 by task 108. A messaging feature of bridge 116 may be used to communicate this starting address of DSP region 114 to task 108 (block 340). In some embodiments, application 106 sends a message to task 108 with the starting address of reserved DSP region 114 as one of the message parameters. In other embodiments, the size of the mapped memory region may also be sent to task 108 as one of the message parameters. Task 108 accesses MPU buffer 112 by accessing this starting address of reserved DSP region 114.

Once the base address to the reserved DSP region has been communicated to DSP 104, the DSP performs task 108 (block 350). Various tasks 108 typically comprise accessing and/or processing data in the mapped buffer. Because the mapping information may not yet be available to DSP MMU 125, when tasks 108 attempt to access data in the mapped buffer, there may be instances where a translation look-aside buffer (TLB) miss occurs. A TLB miss causes an interrupt in the MPU and generally occurs each time tasks 108 attempt to access an unmapped address. When a TLB miss interrupt occurs, bridge 116 being executed by MPU 102 searches the PTEs for the address causing the TLB miss. If the address causing the TLB is found in the PTEs, then the corresponding physical address is supplied to MMU 125 and tasks 108 can resume processing data in the mapped buffer. Otherwise, if there is no mapping information for the address causing the TLB miss in the PTEs, an MMU fault is signaled. An MMU fault generally indicates that a DSP task 108 has attempted to access some data in a portion of external memory 110 that has not yet been mapped. In some embodiments, a TLB miss does not generate an interrupt when the MMU hardware walking table logic is enabled, for example; the MMU in such embodiments preferably resolves this TLB miss by itself.

After task 108 has been performed and DSP 104 no longer needs access to the data in MPU buffer 112, MPU buffer 112 may be unmapped from DSP region 114 (block 360). The function of unmapping may be accomplished by invoking an API function. An unmap API function preferably clears the previously mapped PTEs—and DSP memory region 114—of any references to the MPU buffer 112. In addition to unmapping buffer 112, reserved DSP memory region 114 may also be freed for future use. Freeing DSP region 114 (block 370) for future use may be accomplished, in some embodiments, by calling an API function. An unreserved memory API function may be executed by DSP 104. In other embodiments, the same reserved DSP region can be re-used without being unreserved, by mapping the same reserved DSP region to another MPU buffer 112 and repeating the functions of blocks 310 through 330.

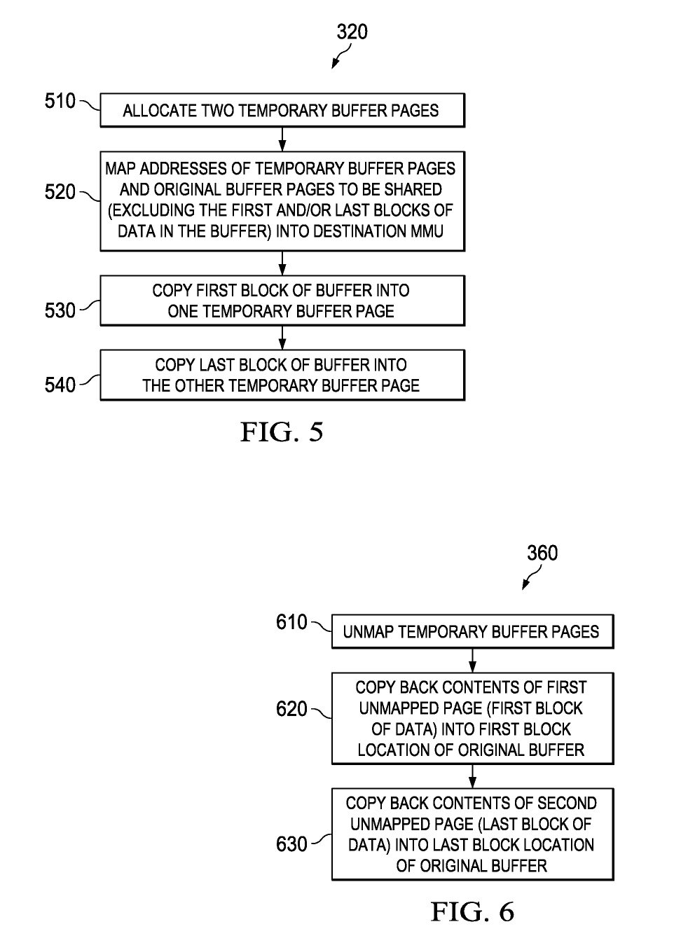

Turning to FIG. 5, embodiments for optimizing mapping of MPU buffer 112 will be further discussed. FIG. 5 is a more detailed block diagram of block 320 of FIG. 3, and which drawing illustrates an exemplary method of mapping, according to embodiments. Specifically, MPU 102 directs DSP bridge 116 to allocate two temporary buffer pages worth of memory in external memory 110 or re-uses two temporary buffer pages worth of any pre-allocated memory, depending upon embodiment (block 510). The size of each of the temporary buffer pages is preferably 4 KB. The addresses of the two allocated temporary buffer pages together with the addresses of the buffer pages, excluding the first and last blocks of data in the buffer to be shared, are mapped by DSP MMU 125 to reserved DSP memory region 114 (block 520). DSP bridge 116 copies the first block of data in MPU buffer 112—which is typically less than 4 KB, and therefore page-unaligned—into one of the temporary buffer pages (block 530) and copies the last block of data in MPU buffer 112—also typically less than 4 KB, and therefore page-unaligned—into the other allocated temporary buffer page (block 540). No other portion of the buffer is copied, thereby saving considerable memory and power requirements, as well as reducing processing overhead. All of the original buffer pages (second block through next-to-last block) of MPU buffer 112, together with the two temporary buffer pages that now contain the data from the first and last data blocks, are flushed to physical memory. It should be appreciated that “next-to-last” means that, if there are M blocks of data, where M is a positive integer, then the next-to-last block of data is the one which is M−1 and immediately precedes the last block of data. Thus, the contents of the temporary buffer pages are now page-aligned. Moreover, the addresses of the temporary buffer pages—instead of the locations of the first and last blocks of the original inaccessible buffer—have been mapped to reserved DSP memory region 114.

It should be understood that on the occasion that only one of the first or last blocks of data is not page-aligned, while the other of the first or last blocks of data is page-aligned, the functionality of block 530 or 540 corresponding to the page-aligned block of data (first or last), respectively, in FIG. 5 may be omitted. For example, and not by way of limitation, if the first block is page-aligned, but the last block is not page-aligned, then in some embodiments, the functionality of block 530 may be omitted. In such case, if the functionality of block 530 is omitted, only the contents of the last block of data will be copied into a temporary buffer page. Similarly, if the first block is not page-aligned, but the last block is page-aligned, in some embodiments, the functionality of block 540 may be omitted. In such case, if the functionality of block 540 is omitted, only the contents of the first block of data will be copied into a temporary buffer page. It should be further understood that the functionality of block 520 may also be appropriately changed to exclude the addresses of only the first or last block of data, if the first or last block of data, respectively, is page-aligned.

By employing embodiments, private data from a cache line is not copied because only the portion of the buffer to be shared—and not the private data—is copied. The portion that is to be shared is defined by a start address and an end address. Based on these addresses, MPU 102 directs the copying of the public data to be shared to a temporary buffer which is page-aligned. MPU 102 directs DSP 104's MMU 125 to map the copied public data to the DSP's private reserved DSP region 114 to enable DSP 104 to access (see) the contents. Each of the temporary page-sized buffers is located in external memory and each is assigned (allocated) per task. When the data to be copied is less than the size of the temporary buffer, in some embodiments, the data can be padded as established by a predetermined algorithm. As noted earlier, although the page size for this discussion is preferably 4 KB, the page size may be a different predetermined page size, depending upon embodiment.

In some embodiments, DSP task 108 is alerted that MPU buffer 112 is accessible, and commences with accessing the buffer as described above in connection with the example embodiment of FIG. 3. In other embodiments, DSP task 108 simply keeps trying to access the buffer—triggering faults—until the MPU buffer is accessible. In still further embodiments, instead of alerting DSP task 108, the buffer contents are sent by MPU 102 to DSP 104. Regardless, DSP task 108 commences with accessing and/or processing the data from the buffer.

As noted above, after task 108 has been performed and DSP 104 no longer needs access to the data in MPU buffer 112, MPU buffer 112 may be unmapped from DSP region 114 (block 360). FIG. 6 is a more detailed block diagram of block 360 of FIG. 3, and which drawing illustrates an exemplary method of unmapping, according to embodiments. Specifically, DSP 104's MMU 125 unmaps or calls for an API function to unmap MPU buffer 112 from DSP memory region 114 which, at this point, comprises the addresses of the temporary buffer pages together with the original intervening pages (the second block through the next-to-last block of original content of MPU buffer 112)(block 610). As part of unmapping, DSP bridge 116 copies back (or calls an API to copy back) the contents of the first unmapped page—corresponding to the data from the original first block—into the first block location of original buffer (block 620), and copies back the contents of the second unmapped page—corresponding to the data from the original last block—into last block location of original buffer (block 630). It should be appreciated that at least one of the first and last blocks of data have no doubt been written to by DSP 104, so the actual contents of those pages may have been modified. Regardless, the first and last blocks are always copied back when each buffer is returned, so that both processors see the correct data, i.e., data coherency is maintained. Thus, the contents of the temporary 4 KB pages—as processed by DSP task 108—are copied back into the original positions and the content of the original first and last blocks are written over with the processed contents of the respective first and last blocks located in the two temporary pages, which essentially synchronizes the buffer. The rest of unmapping and unreserving DSP region 114 continues as earlier described.

It should be understood that on the occasion that only one of the first or last blocks of data is not page-aligned, while the other of the first or last blocks of data is page-aligned, the functionality of block 620 or 630 corresponding to the page-aligned block of data (first or last), respectively, in FIG. 6 may be omitted. For example, and not by way of limitation, if the first block is page-aligned, but the last block is not page-aligned, then in some embodiments, the functionality of block 620 may be omitted. In such example, only the contents of the unmapped temporary buffer page corresponding to the last block of data will be copied back into its respective location (in this example, the location of the last block) of the original buffer. Similarly, if the first block is not page-aligned, but the last block is page-aligned, in some embodiments, the functionality of block 630 may be omitted. In this example, only the contents of the unmapped temporary buffer page corresponding to the first block of data will be copied back into its respective location (in this example, the location of the first block) of the original buffer.

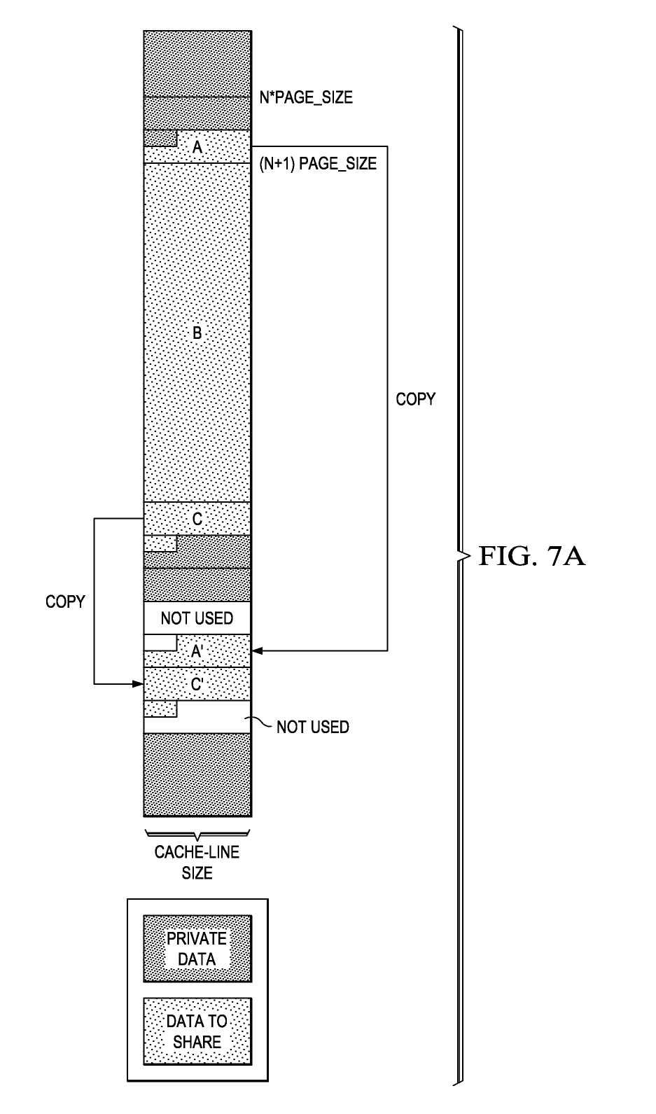

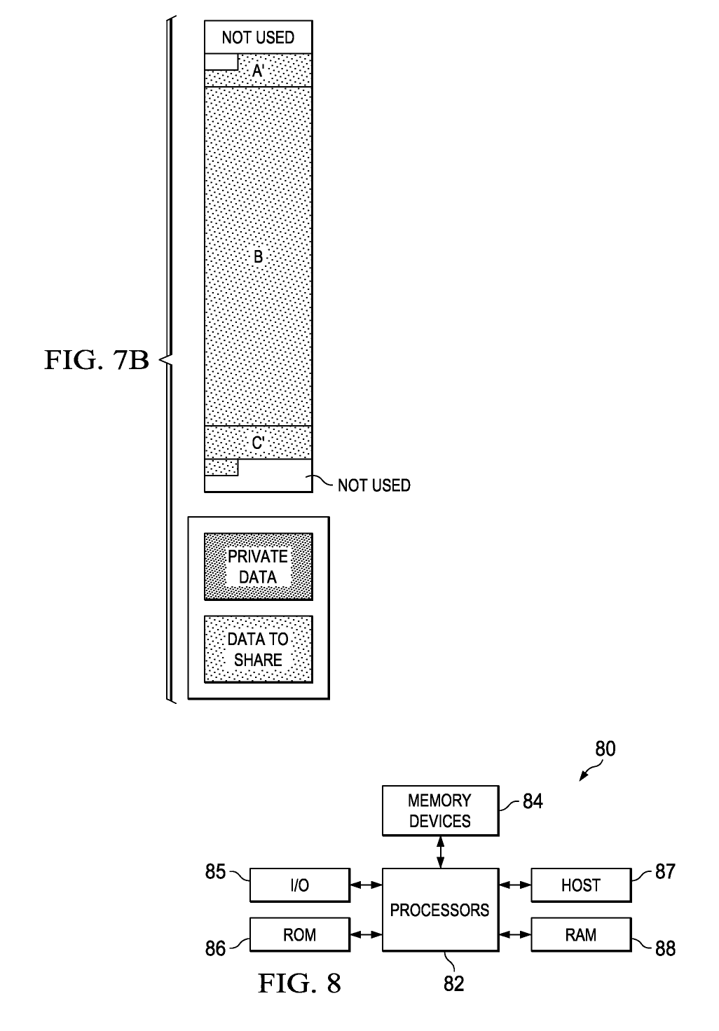

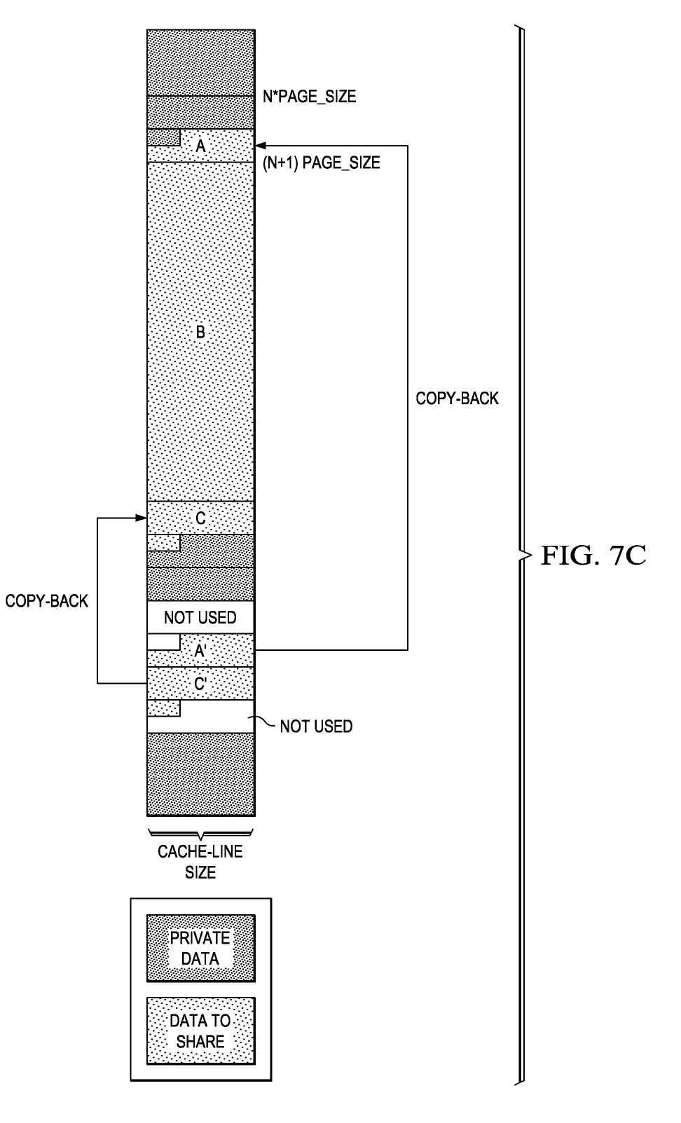

FIG. 7 illustrates an example of memory blocks as mapping and unmapping occurs according to embodiments. In this example, the copying of the first and last blocks of data occur prior to the mapping of page addresses, but are otherwise consistent with the discussions above. It should be appreciated that the mapping and copying functions can almost simultaneously occur, or that mapping of the addresses prior to the contents being copied may occur, depending upon embodiments. An example buffer of data is illustrated at a first time (designated as “1” in FIG. 7), comprising private data, data which MPU 102 wishes to share with DSP 104, and portions of memory which are—for whatever reason—“Not used”. The example buffer of data to be shared comprises first block of data A, intervening blocks of data (second block of data through next-to-last or block of data) B, and last block of data C. It should be understood that the block(s) corresponding to “B” in this drawings may also be referred to as remaining blocks. Per embodiments, the first block of data, A, which is less than a full page size, and part of which is less than a cache-line size (so is not page-aligned and is not cache-aligned), is copied into temporary page-sized buffer designated in the drawing as A′. Similarly, the last block of data, C, which is also less than a full page size, and a portion of which is less than a cache-line size (so is also not page-aligned and is not cache-aligned), is copied into temporary page-sized buffer designated in the drawing as C′.

At a later time (designated as “2” in FIG. 7), DSP 104's MMU 125 is programmed to map—or call an API to map—the page containing only A′ (together with the rest of the page containing memory which is unused), the page containing B, and the page containing only C′ (together with the remainder of the page containing memory which is unused)—the total of which becomes the MPU buffer 112 which is now accessible in the physical memory—into DSP reserved memory region 114.

Once DSP task 108 has completed its functions, and no longer needs access to the contents of MPU buffer 112, DSP 104's MMU 125 unmaps MPU buffer 112 (designated as “3” in FIG. 7). MPU 102 directs DSP bridge 116 to copy block A′ back into the original block A location, thereby effectively writing over the contents at block A. Similarly, MPU 102 directs DSP bridge 116 to copy C′ back into the original block C location, thereby effectively writing over the contents at block C. As a result, MPU 102 now sees the same data that DSP 104 saw (data content coherence), without MPU 102 unwillingly sharing and/or DSP 104 accidentally taking any of MPU 102's private data (memory protection).

It should be understood that in the various embodiments, the first block may be either non-cache aligned or non-page aligned, or both. Of course, if it is page-aligned, it is also cache-line aligned because a cache-line is normally aligned on a page. If the first block is not cache-line aligned, embodiments resolve the coherency issue discussed above. Similarly, if the first block is not page aligned, embodiments resolve the memory protection issues discussed above. It should be further understood that the last block might not end on a full cache-line—as is depicted in FIG. 7. Again, in such scenarios, embodiments resolve the coherency and memory protection issues discussed above.

As yet another example, the last block may not exist because the buffer finished on a full page. In such scenario, embodiments will copy the first block A (which is less than a full page size) into temporary page-sized buffer designated in the example of FIG. 7 as block A′, but not last block C (because it does not exist as a separate page in this further discussion example). At a later time (designated as “2” in FIG. 7), DSP 104's MMU 125 is programmed to map—or call an API to map—the page containing only A′ (together with the rest of the page containing memory which is unused), and the remaining page containing B—the total of which becomes the MPU buffer 112 which is now accessible in the physical memory—into DSP reserved memory region 114.

Once DSP task 108 has completed its functions, and no longer needs access to the contents of MPU buffer 112, DSP 104's MMU 125 unmaps MPU buffer 112 (designated as “3” in FIG. 7). MPU 102 directs DSP bridge 116 to copy block A′ back into the original block A location, thereby effectively writing over the contents at block A. As a result, MPU 102 now sees the same data that DSP 104 saw (data content coherence), without MPU 102 unwillingly sharing and/or DSP 104 accidentally taking any of MPU 102's private data (memory protection).

As yet a further example, the first block may not exist because the buffer began on a full page. In such scenario, embodiments will copy the last block C (which is less than a full page size) into temporary page-sized buffer designated in the example of FIG. 7 as block C′, but not first block A (because it does not exist as a separate page in this further discussion example). At a later time (designated as “2” in FIG. 7), DSP 104's MMU 125 is programmed to map—or call an API to map—the remaining page containing B and the page containing only C′ (together with the rest of the page containing memory which is unused)—the total of which becomes the MPU buffer 112 which is now accessible in the physical memory—into DSP reserved memory region 114.

Once DSP task 108 has completed its functions, and no longer needs access to the contents of MPU buffer 112, DSP 104's MMU 125 unmaps MPU buffer 112 (designated as “3” in FIG. 7). MPU 102 directs DSP bridge 116 to copy block C′ back into the original block C location, thereby effectively writing over the contents at block C. As a result, MPU 102 now sees the same data that DSP 104 saw (data content coherence), without MPU 102 unwillingly sharing and/or DSP 104 accidentally taking any of MPU 102's private data (memory protection).

By limiting the quantity of data to copy vs. performing a full copy of the entire MPU buffer 112, performance is improved while utilizing less power and memory. By forcing the un-aligned first and/or last blocks to become at least page-aligned, data content coherence is promoted. Moreover, these advantages are achieved without dedicated hardware—so embodiments are relatively platform independent.

The systems and methods described above may be implemented on any general-purpose computer with sufficient processing power, memory resources, and network throughput capability to handle the necessary workload placed upon it. FIG. 8 illustrates an exemplary, general-purpose computer system suitable for implementing one or more embodiments of a system to respond to signals as disclosed herein. Computer system 80 includes processors 82 (which may be referred to as central processor units or CPUs, main processing units or MPUs, digital signal processors or DSPs, etc., including combinations thereof) that are in communication with memory devices including secondary storage 84, read only memory (ROM) 86, random access memory (RAM) 88, input/output (I/O) 85 devices, and host 87. The processors may be implemented as one or more chips.

Secondary storage 84 typically comprises one or more disk drives or tape drives and is used for non-volatile storage of data and as an over-flow data storage device if RAM 88 is not large enough to hold all working data. Secondary storage 84 may be used to store programs that are loaded into RAM 88 when such programs are selected for execution. ROM 86 is a non-volatile memory device that typically has a small memory capacity relative to the larger memory capacity of secondary storage. RAM 88 is used to store volatile data and sometimes to store instructions. Access to both ROM 86 and RAM 88 is typically faster than to secondary storage 84. External memory manager 126 and/or DSP bridge, in some embodiments, may be part of host 87 or co-located with either of processors 82.

I/O devices 85 may include printers, video monitors, liquid crystal displays (LCDs), touch screen displays, keyboards, keypads, switches, dials, mice, track balls, voice recognizers, card readers, paper tape readers, or other well-known input devices. Host 87 may interface to Ethernet cards, universal serial bus (USB), token ring cards, fiber distributed data interface (FDDI) cards, wireless local area network (WLAN) cards, and other well-known network devices. Host 87 may enable processors 82 to communicate with an Internet or one or more intranets. With such a network connection, it is contemplated that processors 82 might receive information from the network, or might output information to the network in the course of performing the above-described processes. Processors 82 execute instructions, codes, computer programs, and scripts which they access from a hard disk, floppy disk, optical disk (these various disk-based systems may all be considered secondary storage 84), ROM 86, RAM 88, or the host 87.

While the foregoing describes preferred embodiments, alternative embodiments exist. For example, the various functions of FIGS. 3, 5 and/or 6 are not necessarily sequentially performed; the functions may be performed in various orders. Additionally, each function of FIGS. 3, 5 and/or 6 may be repeated multiple times.

Many modifications and other embodiments of the invention will come to mind to one skilled in the art to which this invention pertains having the benefit of the teachings presented in the foregoing descriptions, and the associated drawings. For example, the above discussion describes the construction and operation of system and method embodiments of a multi-core processor device which enable efficient use of memory in a multi-processor architecture. It should be appreciated that although embodiments were described herein with respect to a two-core processing device, that embodiments are not so limited; in fact, more processors may be found in some embodiments. Furthermore, some embodiments alternatively comprise separate processing devices which cooperatively share memory. It should also be noted that although some disclosed embodiments are implemented in form of software instructions that are contained in a computer-readable medium and executable by a computer, the present disclosure and appended claims are not limited to such arrangement. In alternative embodiments, hard-wired circuitry may be used in place of or in combination with software instructions. Thus, embodiments are not limited to any specific combination of hardware circuitry and software.

Moreover, besides those embodiments disclosed herein, other processor architectures and embodiments may be used; thus, this disclosure and the claims which follow are not limited to any particular type of processor architecture. Therefore, the above discussion is meant to be illustrative of the principles and various embodiments of the disclosure; it is to be understood that the invention is not to be limited to the specific embodiments disclosed. Although specific terms are employed herein, they are used in a generic and descriptive sense only and not for purposes of limitation. It is intended that the following claims be interpreted to embrace all such variations and modifications.

What is claimed is:

1. A system, comprising:
a plurality of processor cores;
memory coupled to at least two of the plurality of processor cores; and
a program that is executable at least in part by one of the at least two processor cores, wherein the program causes a first processor core to map a memory portion that is inaccessible to a second processor core to at least a segment of a pre-reserved region of memory addresses used by the second processor core to enable the second processor core to access the contents of the memory portion, the mapped memory portion comprising at least one temporary page and all pages of data in a buffer to be shared excepting at least one of a first block of data and a last block of data, the at least one of the first and last blocks of data copied into a respective temporary page, and at least one of the first and last blocks of data are unaligned prior to being copied into its respective temporary page.

2. The system of claim 1, wherein a memory management application allocates the at least one temporary buffer page.

3. The system of claim 1, wherein a memory management application calls an application programming interface (API) to allocate the at least one temporary buffer page.

4. The system of claim 1, wherein at least one of the first block of data and the last block, prior to being copied into its respective temporary page, comprises a portion of data to be shared on a same cache line as a portion of data not to be shared.

5. The system of claim 1, wherein the program causes the at least one temporary page to be copied back to inaccessible memory location of the at least one block of data originally copied when the second processor core no longer needs access.

6. The system of claim 1, wherein the program causes the temporary page size to be 4 KB.

7. A system, comprising:
a plurality of processor cores; and
a program that is executable at least in part by one of the plurality of processor cores, wherein the program causes at least one of a first block and a last block of a first buffer of a first processor core to be copied into at least one respective page-aligned temporary buffer, the first buffer inaccessible by a second processor core, the program further causes mapping of beginning addresses of the at least one temporary buffer and memory portions corresponding to remaining blocks of the first buffer into a second processor core's memory, and the program also causes the contents of the mapped at least one temporary buffer and memory portions to be flushed into physical memory.

8. The system of claim 7, wherein the copying of at least one of the first and last blocks occurs prior to the mapping of the temporary buffer.

9. The system of claim 7, wherein the program further causes the at least one temporary buffer to be copied back to original memory location of the at least one block of data originally copied.

10. The system of claim 7, wherein the program further causes the at least one temporary buffer's page size to be 4 KB.

11. The system of claim 7, wherein at least one of the first block and the last block are unaligned at page boundaries prior to being copied into its respective temporary buffer.

12. A computer-readable storage medium containing a program which, when executed by a first processor core, causes such processor core to: copy at least one of a first block and a last block of a first buffer of a first processor core into at least one respective page-aligned temporary buffer, the first buffer inaccessible by a second processor core; map beginning addresses of the at least one temporary buffer and memory portions corresponding to remaining blocks of the first buffer into a second processor core's memory; and flush the contents of the mapped temporary buffers and memory portions into physical memory

13. The storage medium of claim 12, wherein the program further causes the first processor core to copy at least one of the first block and last block of the first buffer if at least one of the first block of data and the last block, prior to being copied into its respective temporary page, comprise a portion of data to be shared on a same cache line as a portion of data not to be shared.

14. The storage medium of claim 12, wherein the program further causes the first processor core to copy back the contents of the at least one temporary buffer to original memory location of the at least one block of data of the first buffer originally copied, when the second processor core no longer needs access.

15. The storage medium of claim 12, wherein the program further causes the first processor core to allocate each temporary buffer's page size at 4 KB.

16. A computer-implemented method, comprising:
mapping by a first processor, of a memory portion that is inaccessible to a second processor to at least a segment of a pre-reserved region of memory addresses used by the second processor to enable the second processor to access the contents of the memory portion, the mapped memory portion comprising at least one temporary page and all pages of data in a buffer to be shared excepting at least one of a first block of data and a last block of data; and
copying the contents of at least one of the first block of data and the last block of data into its respective temporary page, at least one of the first and last blocks of data are unaligned prior to being copied into its respective temporary page.

17. The method of claim 16, further comprising flushing, by the first processor, of contents of the mapped memory portion into physical memory.

18. The method of claim 16, further comprising sending, by the first processor, the memory portion to second the processor for processing.

19. The method of claim 16, further comprising accessing, by second processor, the memory portion for processing.

20. The method of claim 16, further comprising copying back, by the first processor, the contents of at least one of the temporary page to original memory location of the at least one block of data of the buffer originally copied when the second processor core no longer needs access.

21. The method of claim 16, wherein the copying further comprises copying the contents of at least one of the first block of data and the last block of data into its respective temporary page, at least one of the first block of data and the last block of data, prior to being copied into its respective temporary page, comprises a portion of data to be shared on a same cache line as a portion of data not to be shared.

22. A processor core, comprising:
a memory management unit able to map a memory buffer of the processor core, excluding a first data block and a last data block of the memory buffer, to a reserved region of memory addresses of another processor core, the memory management unit further able to copy at least one of the first data block and the last data block to a respective temporary page and to map the at least one temporary page to the reserved region of memory addresses of the other processor core, and the memory management unit further able to flush the contents of the mapped portions of the memory buffer and at least one temporary page to physical memory, at least one of the first and last blocks of data are unaligned prior to being copied into its respective temporary page.

23. The processor core of claim 22, wherein the memory management unit is further able to copy back the contents of the at least one temporary page to the corresponding location of the memory buffer of the processor core.

24. The processor core of claim 22, wherein at least one of the first block of data and the last block of data, prior to being copied into its respective temporary page, comprises a portion of data to be shared on a same cache line as a portion of data not to be shared.

25. The processor core of claim 22, wherein the memory management unit is further able to allocate each temporary page's size at 4 KB.
